(19) United States
(12) Patent Application Publication
(10) Pub. No.: US 2016/0080153 A1
(43) Pub. Date: Mar. 17, 2016

(54) DEVICE AUTHENTICITY DETERMINATION SYSTEM AND DEVICE AUTHENTICITY DETERMINATION METHOD

(71) Applicant: MITSUBISHI ELECTRIC CORPORATION, Tokyo (JP)

(72) Inventor: Daisuke SUZUKI, Tokyo (JP)

(73) Assignee: MITSUBISHI ELECTRIC CORPORATION, Tokyo (JP)

(21) Appl. No.: 14/785,805

(22) PCT Filed: May 15, 2013
(86) PCT No.: PCT/JP2013/063560

§ 371 Date: Oct. 20, 2015

(51) Int. Cl. H04L 9/32

(52) U.S. Cl. CPC H04L 9/3234

(57) ABSTRACT

Provided is a system for using printed information, which is viewable from an exterior of a device having mounted thereon a semiconductor chip having a PUF function and an encryption function, and includes auxiliary data and the secret information, the system comprising a control terminal for reading and transmitting the printed information, in which the semiconductor chip further has a tampering determination function of temporarily reconstructing, through the encryption function and the PUF function, the secret information being difficult to duplicate with use of the auxiliary data included in the printed information acquired from the control terminal, performing comparison processing between the secret information included in the printed information and the temporarily-reconstructed secret information being difficult to duplicate, and determining that tampering has occurred when detecting a mismatch between the secret information included in the printed information and the temporarily-reconstructed secret information being difficult to duplicate.

### TECHNICAL FIELD

The present invention relates to a device authenticity determination system and device authenticity determination method for detecting a counterfeit product or tampering of a built-in device having a semiconductor chip mounted thereon.

### BACKGROUND ART

In recent years, as more built-in devices represented by mobile phones are becoming subjected to networking, the built-in device is increasingly demanded to perforin processing involving information security in order to maintain concealment of data handled by the built-in device and integrity thereof, and authenticate the built-in device itself.

Such processing involving the information security is implemented by an encryption algorithm or an authentication algorithm. Now, consideration is given to a system in which two LSIs perform authentication to confirm that one device to which the other device is connected is valid. As a specific example thereof, there is a conceivable case where an LSI mounted on a mobile phone main body authenticates an LSI mounted on a battery thereof to confirm that the battery is allowed to be connected thereto. That is, the main body to be used as the master verifies the validity and genuineness of the peripheral devices that are to be slaves.

In general, such a function is implemented by an authentication protocol using encryption. An example of two authentication protocols that differ in encryption scheme is described below.

### Example 1

### Authentication Protocol Based on Common Key Cryptosystem

(1) A secret key MK is stored in advance in an LSI mounted on a slave A. Further, the secret key MK of the slave A is also registered in a master B.
(2) At the time of authentication, the master B generates a random number r, encrypts the random number r with the use of the secret key MK to generate c, and transmits the generated c to the slave A. The generated c in this case is represented by c=E_{MK}(r).
(3) The slave A decrypts c with the use of MK to obtain r′, and sends r′ to the master B. The generated r′ in this case is represented by r′=D_{MK}(c).
(4) When r=r′, the master B issues a notification that the slave A is a genuine product. When r≠r′, the master B issues a notification that the slave A may be a counterfeit product.

It is a point of this protocol that the authentication can be successfully passed as long as the master and the slave each have the same secret key MK.

### Example 2

### Authentication Protocol Based on Public Key Cryptosystem

(1) A secret key SK is stored in advance in an LSI mounted on a slave A. Further, a public key PK corresponding to the secret key MK of the slave A is also registered in a master B.
(2) At the time of authentication, the master B generates a random number r, encrypts the random number r with the use of the public key PK to generate c, and transmits the generated c to the slave A. The generated c in this case is represented by c=E_{PK}(r).
(3) The slave A decrypts c with the use of SK to obtain r′, and sends r′ to the master B. The generated r′ in this case is represented by r′=D_{SK}(c).
(4) When r=r′, the master B issues a notification that the slave A is a genuine product. When r≠r′, the master B issues a notification that the slave A may be a counterfeit product.

It is a point of this protocol that the authentication can be successfully passed as long as the slave has the secret key SK corresponding to the public key PK registered in the master. It is a major premise in executing those protocols that the slave A “securely” holds the secret key MK or SK. The word “securely” means that it is difficult for a person who is not legitimately allowed to access the device to read or tamper with the secret key.

As a method of securely holding the secret information, there is a technology called a physical unclonable function (PUF). One of major features of the PUF resides in that the secret key K is not held within the device as non-volatile digital data.

There are several embodiments of such a PUF. “Signal generator based device security” disclosed in Patent Literature 1 and a “semiconductor device identifier generation method and semiconductor device” disclosed in Patent Literature 2 are representative examples of such embodiments.

Now, secret key generation to be performed by the PUF is briefly described. As the secret key generation to be performed by the PUF, there is known a method using a fuzzy extractor (hereinafter abbreviated as “FE”). Processing procedures to be performed by the FE are shown in tables below as an algorithm 1 and an algorithm 2.

TABLE 1
Algorithm 1: Key Generation Processing Gen to be performed by FE

Setting: (n,k,2t + 1) error correction code C, general-purpose hash
function h_{A}
Input: l · n-bit PUF response W = (w₁,w₂,...,wₗ).
Output: (K,S)←Gen(W), u-bit key K, l · n-bit auxiliary data
S = (s₁,s₂,...,sₗ)
1: i = 1 to l do
2: generate k-bit random number rᵢ
3: cᵢ←Encode_{c}(rᵢ)
4: sᵢ←wᵢ ⊕ cᵢ
5: end for
6: K ← h_{A}(w₁,w₂,...,wₗ)
7: return K,S

Algorithm 2: Key Reconstruction Processing Rep to be performed by FE

Setting: (n,k,2t + 1) error correction code C, general-purpose hash
function h_{A}
Input: l · n -bit PUF response W′ = (w′₁,w′₂,...,w′ₗ) ,
l · n -bit auxiliary data S = (s₁,s₂,...,sₗ).
Output: K ← Rep(W′,S), u-bit key K.
1: i = 1 to l do
2: c′ᵢ ← w′ᵢ ⊕ sᵢ
3: cᵢ ← Decode_{c}(c′ᵢ)
4: wᵢ ← cᵢ ⊕ sᵢ
5: end for
6: K ← h_{A}(w₁,w₂,...,wₗ)
7: return K,S

The algorithm 1 is processing of generating a key corresponding to an initial key for the FE, and the key reconstruction processing of the algorithm 2 is processing of generating the same bit string as that of the initial key. Encode_{C} and Decode_{C} of the algorithm 1 and the algorithm 2 represent encoding processing and correction processing within the error correction code C, respectively. A match between the generated key and the reconstructed key is guaranteed by Expression (1) in tennis of a Hamming distance of a PUF response within the algorithm 1 and the algorithm 2.

∀iε{1, . . . ,l},dis_{Ham}(wᵢ,w′ᵢ)≦t [Math. 1]

Further, when an information amount between chips held by a k-bit PUF output is represented by k′, Expression (2) is an appropriate design parameter.

l=┌u/k′┐ [Math. 2]

### CITATION LIST

### Patent Literature

[PTL 1] JP 2009-524998 A1

[PTL 2] JP 2009-533741 A1

### SUMMARY OF INVENTION

### Technical Problem

However, the related arts have the following problems.

The above-mentioned authentication protocol does not essentially verify the authenticity of the entire built-in device A, but performs the authentication on the LSI incorporated into the built-in device A. Accordingly, for example, this authentication protocol cannot detect a counterfeit product produced by taking out the LSI of the genuine product that has been discarded once or an electronic board having the LSI mounted thereon and replacing other components such as a casing with new components.

Moreover, for a reason such as use of common components for achieving compatibility or cost reduction, when the same LSI or the electronic board having this LSI mounted thereon is used in two types of models including built-in devices A1 and A2, the above-mentioned authentication protocol cannot detect such an illicit action that the component of the model A1, which is less expensive, is altered to construct the model A2, which is more expensive.

The counterfeit product or illicit product produced by those illicit actions may not be capable of achieving a function and performance intrinsic to the genuine product, and hence such a product may cause a trouble or an accident.

Those problems occur because, although a user of the built-in device can verify the device from the exterior of the device such as a package or a casing, it is difficult for the user to detect a mismatch or inconsistency in terms of an internal configuration of the device. A conceivable cause of such problems is that, although the user of the built-in device can verify information printed on the exterior of the device such as the package or the casing visually or the like, it is difficult for the user to verify whether or not the inside of the built-in device is genuine.

The present invention has been made in view of the above-mentioned problems, and has an object to provide a device authenticity determination system and device authenticity determination method, which enable verification as to whether or not there is a match between an LSI mounted on a built-in device or an electronic board having the LSI mounted thereon and information printed on a casing that is viewable from a user of the built-in device.

### Solution to Problem

According to one embodiment of the present invention, there is provided a device authenticity determination system for using printed information, which is viewable from an exterior of a device or a component, the device and component having mounted thereon a semiconductor chip having a PUF function and an encryption function, and includes auxiliary data, for generating secret information being difficult to duplicate with use of the PUF function, and the secret information, the device authenticity determination system comprising a control terminal for reading the printed information, which is viewable, and transmitting the printed information to the semiconductor chip through electronic access means, in which the semiconductor chip further has a tampering determination function of temporarily reconstructing, through the encryption function and the PUF function, the secret information being difficult to duplicate with use of the auxiliary data included in the printed information acquired from the control terminal, performing comparison processing between the secret information included in the printed information and the temporarily-reconstructed secret information being difficult to duplicate, and determining that tampering has occurred when detecting a mismatch between the secret information included in the printed information and the temporarily-reconstructed secret information being difficult to duplicate.

Further, according to one embodiment of the present invention, there is provided a device authenticity determination method to be used for a device authenticity determination system for using printed information, which is viewable from an exterior of a device or a component, the device and the component having mounted thereon a semiconductor chip having a PUF function and an encryption function, and includes auxiliary data, for generating secret information being difficult to duplicate with use of the PUF function, and the secret information, the device authenticity determination method including the steps of: reading, by the control terminal, the printed information, which is viewable, and transmitting the printed information to the semiconductor chip through electronic access means; temporarily reconstructing, by the semiconductor chip, the secret information being difficult to duplicate with use of the auxiliary data included in the printed information acquired from the control terminal; and performing, by the semiconductor chip, comparison processing between the secret information included in the printed information and the temporarily-reconstructed secret information being difficult to duplicate, and determining that tampering has occurred when detecting a mismatch between the secret information included in the printed information and the temporarily-reconstructed secret information being difficult to duplicate.

### Advantageous Effects of Invention

According to the one embodiment of the present invention, through the determination as to whether or not there is a match between the printed information attached to the casing of the built-in device having the semiconductor chip mounted thereon and the printed information generated by the currently-mounted semiconductor chip based on the result of reading the printed information, it is possible to provide the device authenticity determination system and device authenticity determination method, which enable the verification as to whether or not there is a match between the LSI mounted on the built-in device or the electronic board having the LSI mounted thereon and the information printed on the casing that is viewable from the user of the built-in device.

### BRIEF DESCRIPTION OF DRAWINGS

FIG. 1 is an overall configuration diagram of a device authenticity determination system according to a first embodiment of the present invention.

FIG. 2 is a block diagram for illustrating a configuration of printed information according to the first embodiment of the present invention.

FIG. 3 is a flowchart for illustrating a series of processing to be performed between a control terminal and a master device according to the first embodiment of the present invention.

FIG. 4 is a flowchart for illustrating a series of processing to be performed between a server and the master device according to the first embodiment of the present invention.

FIG. 5 is a block diagram for illustrating a configuration of printed information to be adopted in a public key cryptosystem according to the first embodiment of the present invention.

FIG. 6 is a flowchart for illustrating a series of processing to be performed at the time of maintenance according to a second embodiment of the present invention.

FIG. 7 is a block diagram for illustrating a configuration of printed information after a change according to the second embodiment of the present invention.

### DESCRIPTION OF EMBODIMENTS

Now, a description is given of a device authenticity determination system and a device authenticity determination method according to preferred embodiments of the present invention with reference to the drawings.

### First Embodiment

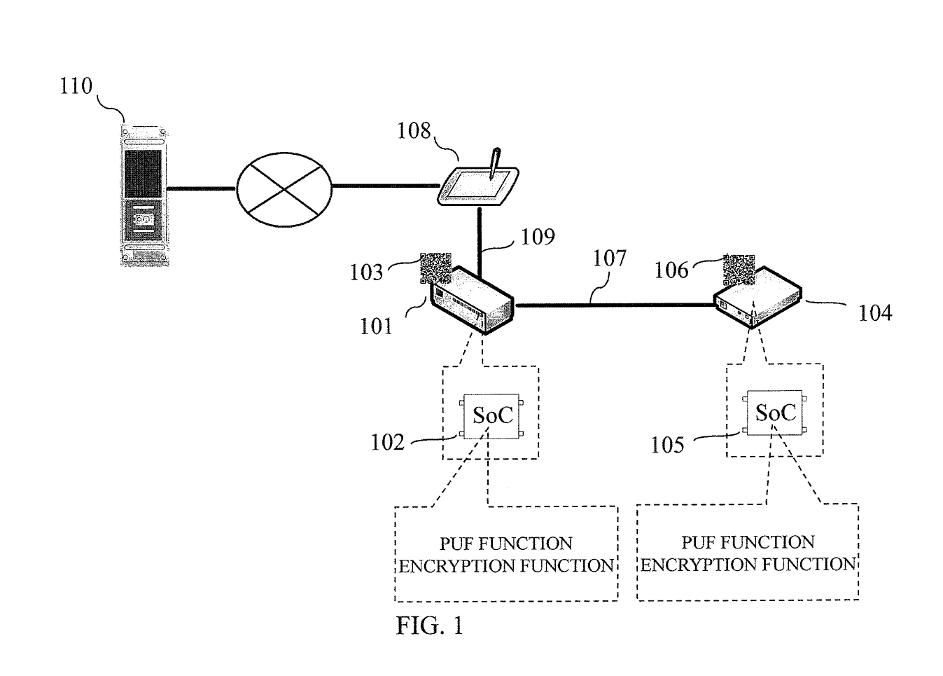

FIG. 1 is an overall configuration diagram of a device authenticity determination system according to a first embodiment of the present invention. A master device 101 has a system on chip (SoC) 102, which is a main constituent element of the device, and the SoC 102 has a PUF function and an encryption function. Further, the master device 101 has printed information 103 on its casing. The printed information includes, in addition to general product-related information I such as a model number, rating, manufacture date, and serial number of the device, a security code, which is a point of the present invention. The printed information is printed in a form of a QR code (trademark) or a barcode, for example.

Similarly, a slave device 104 has an SoC 105 and printed information 106, and is connected to the master device 101 via a communication channel 107. The master device 101 is connected to a control terminal 108 via a communication channel 109, and the slave device 104 is connected to the control terminal 108 via the communication channel 107, the master device 101, and the communication channel 109.

Such connections enable the control terminal 108 to make necessary settings of the master device 101 and the slave device 104. In this case, a device such as a PC or a tablet computer is assumed as the control terminal 108. Further, the control terminal 108 is connected to a server 110 via the Internet. Note that, in the following, when what is common to both of the master device 101 and the slave device 104 is described, those devices are each simply referred to as “device”.

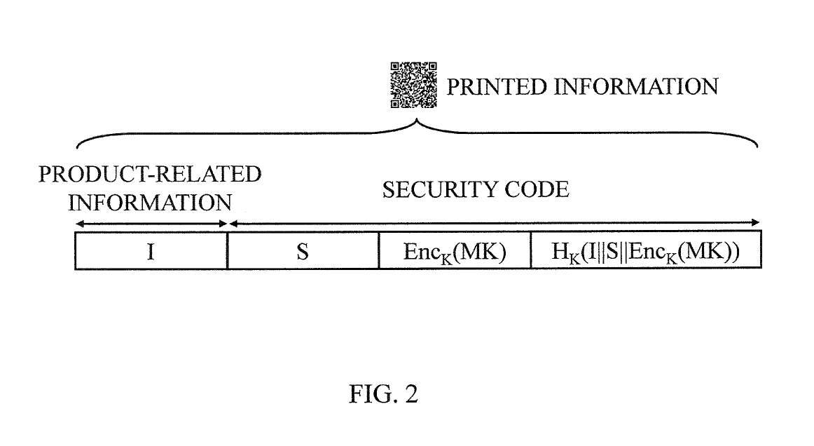

FIG. 2 is a block diagram for illustrating a configuration of the printed information according to the first embodiment of the present invention. The printed information 103 and the printed information 106 are each formed of the product-related information I and the security code. The security code in this case is formed of the following three pieces of information.
Auxiliary data S, which is output from the PUF of the SoC mounted on the device to which the printed information is attached.
Data Enc_{K}(MK), which is obtained by encrypting a master key MK with the use of secret information K, which is generated by the PUF in a manner that corresponds to the auxiliary data S.
A keyed hash value H_{K}(I∥S∥Enc_{K}(MK)) having K as a key, which is generated based on a concatenated data string of I, S, and Enc_{K}(MK). Note that, the HMAC method can be given as an example of calculation of the keyed hash value. In this case, “∥” means concatenation of bits.

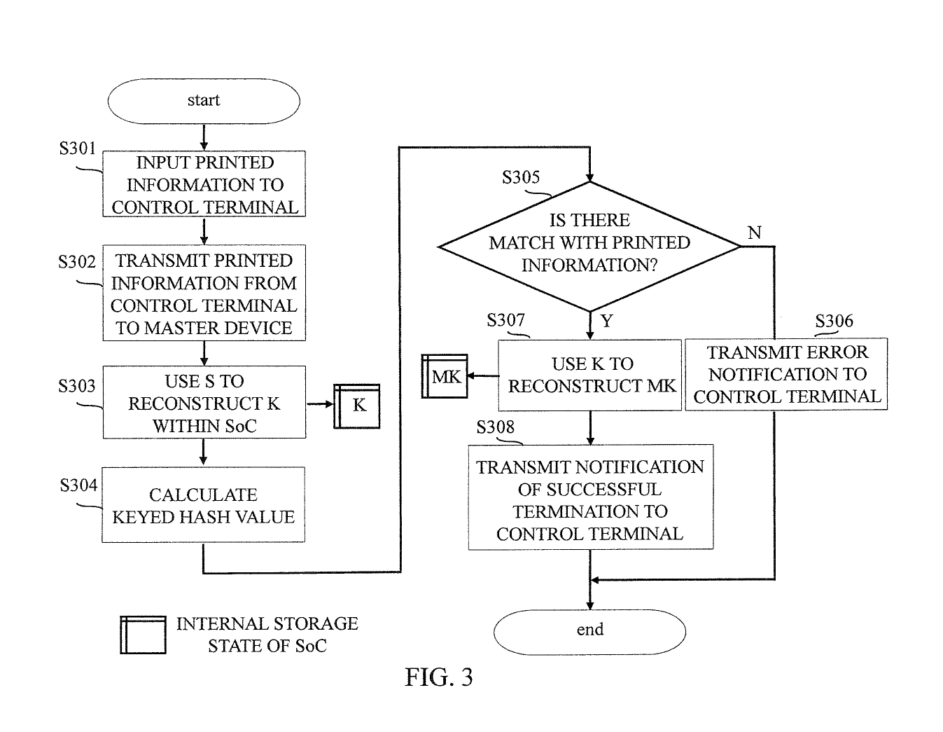

Next, a description is given of an operation of the device authenticity determination system according to the first embodiment having the configuration illustrated in FIG. 1. FIG. 3 is a flowchart for illustrating a series of processing to be performed between the control terminal and the master device according to the first embodiment of the present invention. First, with reference to FIG. 3, a description is given of the operation to be performed between the control terminal 108 and the master device 101.

A purchaser of the device inputs the printed information 103 to the control terminal 108 (Step S301). Next, the printed information is transmitted from the control terminal 108 to the master device 101 (Step S302). The SoC 102 of the master device 101 reconstructs the key MK from the transmitted printed information through the following procedure.

The SoC 102 activates a key reconstruction function of the FE, which is to be performed by the PUF within the SoC. Specifically, the SoC 102 uses the auxiliary data S, which is a part of the printed information, to reconstruct the secret key K as follows (Step S303).

K←Rep(W′,S)

Next, the SoC 102 uses the reconstructed K to calculate the keyed hash value based on the printed information (Step S304). Specifically, the SoC 102 calculates H_{K}(I∥S∥Enc_{K}(MK)), and verifies whether or not there is a match between the calculated value and the keyed hash value of the printed information (Step S305).

In Step S305, when a match between the values cannot be verified, the master device 101 transmits a notification that there is no match to the control terminal 108 (Step S306), and interrupts the processing. On the other hand, when a match between the values can be verified, the processing proceeds to the next step, which is Step S307.

Finally, the SoC 102 uses the secret key K to decrypt Enc_{K}(MK), which is a part of the printed information, to thereby reconstruct MK (Step S307), and the master device 101 transmits a notification of a successful termination to the control terminal 108 (Step S308). Then, the series of processing is completed.

Processing similar to the one for the master device 101 is also performed on the slave device 104. Note that, the slave device 104 communicates to and from the control terminal 108 via the master device 101.

When the printed information does not correspond to the SoC (102, 105) of the device, the true K cannot be reconstructed due to the property of the PUF. Accordingly, there occurs a mismatch with the keyed hash value written as the printed information, which enables the detection of an illicit product.

Next, a description is given of an operation to be performed between the master device 101 and the server 110 via the control terminal 108. This operation is performed in order that the purchaser of the device, who has the genuine product, receives an appropriate service for the device from a manufacturer.

As described above in the operation of FIG. 3, when the purchaser's device is the genuine product, a state in which the correct MK is reconstructed in the SoC is reached. Further, MK is information set by the manufacturer, and the server 110 holds the correct MK. Accordingly, if the purchaser's device is the genuine product, at the time when the operation illustrated in FIG. 3 is finished, a state in which the device and the server 110 share the same key is reached.

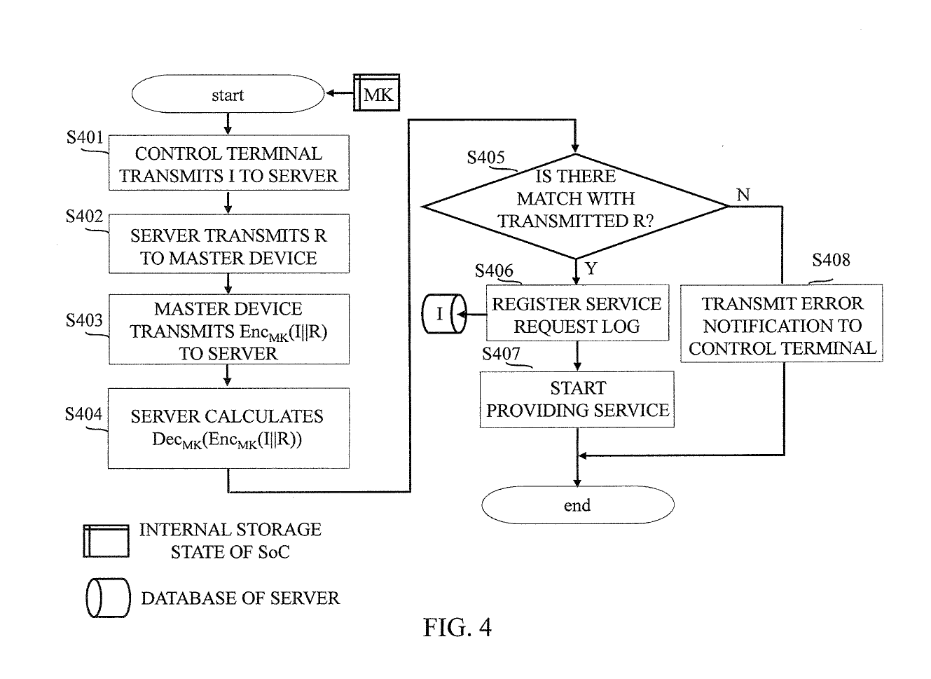

FIG. 4 is a flowchart for illustrating a series of processing to be performed between the server and the master device according to the first embodiment of the present invention. Now, a description is given with reference to FIG. 4. The purchaser of the device uses the control terminal 108 to transmit the product-related information I to the server 110 via the network, and makes a request for the service (Step S401). The server 110 transmits a random number R to the master device 101 via the control terminal 108 (Step S402).

The master device 101 encrypts the product-related information I, which is transmitted to within the SoC in Step S302, and the random number R with the use of MK, and transmits the resultant data to the server 110 via the control terminal 108 (Step S403). Specifically, the master device 101 transmits Enc_{MK}(I∥R).

The server 110 decrypts the received Enc_{MK}(I∥R) with the use of MK (Step S404), and verifies whether or not there is a match of I and R (Step S405). When it is verified that there is a match, the server 110 registers the service request from the product-related information I in a database as a log (Step S406), and starts providing the service (Step S407). On the other hand, when it is verified that there is a mismatch, the server 110 does not provide the service, but issues an error notification to the service request (Step S408).

Processing similar to the one for the master device 101 is also performed on the slave device 104. Note that, the slave device 104 communicates to and from the control terminal 108 via the master device 101.

Examples of the service to be provided by the server 110 include updating of a program and parameter of the device, and notification of maintenance timing. Service information or a part thereof is provided in a form in which the service information is encrypted with the use of the secret information MK, or in such a form as to enable detection of tampering. The device can receive a secure service by performing decryption and detection of tampering with the use of MK held therein.

In the above description of the first embodiment, the common key MK is used to perform the authentication between the server 110 and the control terminal 108. On the other hand, as described above in the “Background Art” section, an equivalent function can be achieved with a public key cryptosystem using a pair of public keys (SK, PK).

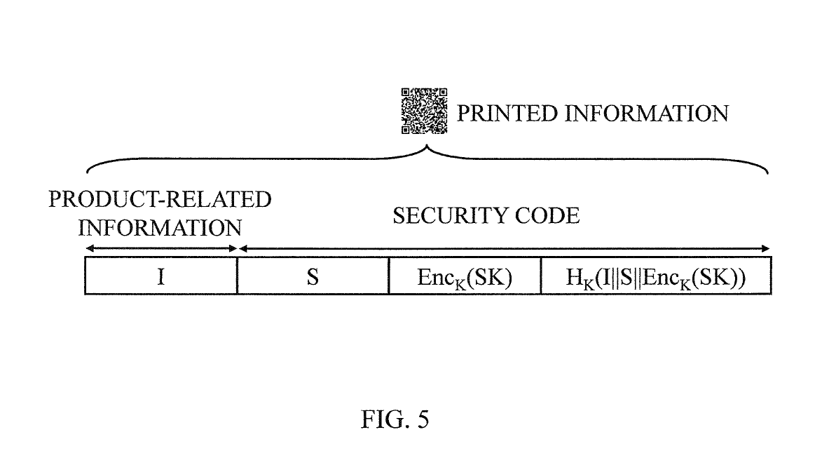

FIG. 5 is a block diagram for illustrating a configuration of printed information to be adopted in the public key cryptosystem according to the first embodiment of the present invention. As compared with the above-mentioned configuration of the printed information to be adopted in the common key cryptosystem illustrated in FIG. 2, in the configuration of FIG. 5, Enc_{K}(SK) is used in place of Enc_{K}(MK) as the printed information, and H_{K}(I∥S∥Enc_{K}(SK)) is used in place of H_{K}(I∥S∥Enc_{K}(MK)) as the keyed hash value. Further, the server 110 uses the public key PK to determine whether or not the service can be provided. In this way, when the public key cryptosystem is adopted, the burden of information management on the authenticator's side can be alleviated.

### Second Embodiment

In a second embodiment of the present invention, a description is given of a case where easiness in changing of the printed information is considered. The manufacturer inputs, to the master device 101, the product-related information I and the secret key MK that are scheduled to be printed on the casing, and causes the master device 101 to execute the following key generation processing.

(K,S)←Gen(W)

The master device 101 encrypts MK with the use of the generated K, and outputs S and Enc_{K}(MK) to the outside. At this time, the SoC does not output K.

In the format of the printed information of FIG. 2 according to the first embodiment described above, the SoC calculates, as the security code, H_{K}(I∥S∥Enc_{K}(MK)) in addition to S and Enc_{K}(MK), and outputs the calculated security code to the outside. However, in the second embodiment, the manufacturer can calculate the keyed hash value by receiving S from the SoC.

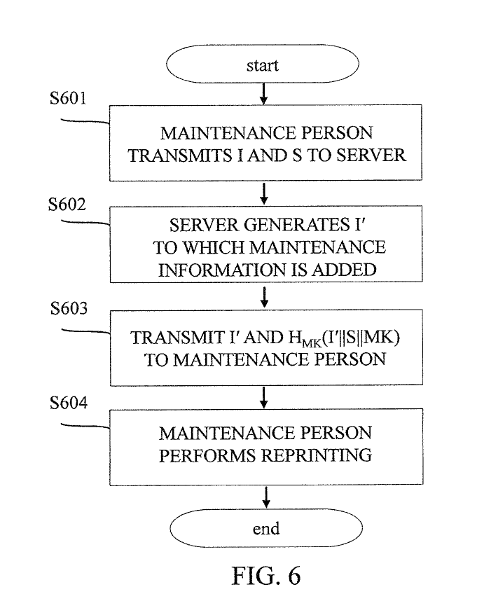

FIG. 6 is a flowchart for illustrating a series of processing to be performed at the time of maintenance according to the second embodiment of the present invention. In this case, maintenance that does not involve a change of the SoC is assumed. Note that, maintenance involving a change of the SoC, namely, maintenance corresponding to replacement of the device, is performed based on the same flow as the one performed at the time of manufacture.

After finishing repairing the device, a maintenance person requests, via the control terminal, the service illustrated in Step S406 of FIG. 4 from the server 110. At this time, it is assumed that the device has transitioned to a state in which the device holds MK within the SoC in accordance with the flowchart of FIG. 3. It is also assumed that the server 110 can separately verify the authenticity of the maintenance person in accordance with general access control.

The maintenance person transmits I and S to the server 110, and makes a printed information reissuance request (Step S601). In response to this request, the server 110 adds, to the product-related information I, information such as execution of maintenance, a date of maintenance, and the maintenance person as information identifiable to the server, to thereby change the product information I to I′ (Step S602).

Further, the server 110 uses the changed I′ and S, and MK held by the server to calculate H_{MK}(I′∥S∥MK), and transmits and H_{MK}(I′∥S∥MK) to the maintenance person (Step S603).

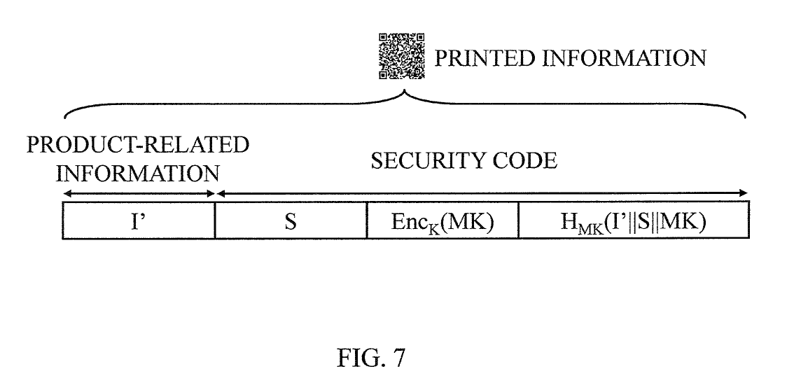

FIG. 7 is a block diagram for illustrating a configuration of the printed information after the change according to the second embodiment of the present invention. The maintenance person generates the printed information in a format illustrated in FIG. 7, and reprints the information on the casing by replacing a current sticker with a new sticker, for example (Step S604).

As described above, through the series of processing of the flowchart illustrated in FIG. 6, the maintenance can be performed without revealing the secret information MK to the maintenance person, and hence it is possible to reduce a threat to this system.

1. A device authenticity determination system for using printed information, which is viewable from an exterior of a device or a component, the device and the component having mounted thereon a semiconductor chip having a PUF function and an encryption function, and includes auxiliary data, for generating secret information being difficult to duplicate with use of the PUF function, and the secret information,
the device authenticity determination system comprising a control terminal for reading the printed information, which is viewable, and transmitting the printed information to the semiconductor chip through electronic access means,
wherein the semiconductor chip further has a tampering determination function of temporarily reconstructing, through the encryption function and the PUF function, the secret information being difficult to duplicate with use of the auxiliary data included in the printed information acquired from the control terminal, performing comparison processing between the secret information included in the printed information and the temporarily-reconstructed secret information being difficult to duplicate, and determining that tampering has occurred when detecting a mismatch between the secret information included in the printed information and the temporarily-reconstructed secret information being difficult to duplicate.

2. A device authenticity determination system according to claim 1,
wherein the printed information further comprises information obtained by protecting second secret information set by a manufacturer of the device or the component with use of the secret information being difficult to duplicate, and
wherein through the encryption function and the PUF function, the semiconductor chip reconstructs the second secret information after reconstructing the secret information being difficult to duplicate, and through the tampering determination function, performs comparison processing between the second secret information set by the manufacturer and the reconstructed second secret information, and determines that the tampering has occurred when detecting a mismatch between the second secret information set by the manufacturer and the reconstructed second secret information being difficult to duplicate.

3. A device authenticity determination system according to claim 1, wherein the semiconductor chip performs the comparison processing in the tampering determination function by comparing results of hash calculation using the secret information as key information.

4. A device authenticity determination system according to claim 1, wherein the semiconductor chip verifies appropriateness of the reconstructed secret information being difficult to duplicate through hash calculation for determining appropriateness.

5. A device authenticity determination system according to claim 2, wherein the semiconductor chip verifies appropriateness of the reconstructed second secret information through hash calculation for determining appropriateness.

6. A device authenticity determination system according to claim 2, further comprising a server connected to the control terminal via a network,
wherein the semiconductor chip transmits, through the control terminal, the reconstructed second secret information to the server via the network, and
wherein the server compares the second secret information reconstructed by the semiconductor chip with second secret information held by itself to verify validity of the device or the component having the semiconductor chip mounted thereon, and after verifying the validity when a comparison result indicates a match between the second secret information reconstructed by the semiconductor chip and the second secret information held by itself, provides service information to the device or the component.

7. A device authenticity determination system according to claim 6,
wherein the server encrypts the service information with use of the second secret information, and transmits the encrypted service information, and
wherein the semiconductor chip that has transmitted the reconstructed second secret information acquires the service information encrypted with use of the second secret information, and decrypts the service information with use of the second secret information reconstructed by itself, to thereby acquire the service information from the server.

8. A device authenticity determination system according to claim 6,
wherein based on an operation of a maintenance person, the control terminal transmits a printed information reissuance request comprising the auxiliary data to the server,
wherein when receiving the printed information reissuance request from the control terminal, the server uses the second secret information to generate new printed information to which maintenance information is added, and returns the generated new printed information to the control terminal that has transmitted the printed information reissuance request, and
wherein the control terminal reprints the new printed information in order that the printed information, which is viewable, is updated with the received new printed information.

9. A device authenticity determination method to be used for a device authenticity determination system for using printed information, which is viewable from an exterior of a device or a component, the device and the component having mounted thereon a semiconductor chip having a PUF function and an encryption function, and includes auxiliary data, for generating secret information being difficult to duplicate with use of the PUF function, and the secret information,
the device authenticity determination method including the steps of:
reading, by a control terminal, the printed information, which is viewable, and transmitting the printed information to the semiconductor chip through electronic access means;
temporarily reconstructing, by the semiconductor chip, the secret information being difficult to duplicate with use of the auxiliary data included in the printed information acquired from the control terminal; and
performing, by the semiconductor chip, comparison processing between the secret information included in the printed information and the temporarily-reconstructed secret information being difficult to duplicate, and determining that tampering has occurred when detecting a mismatch between the secret information included in the printed information and the temporarily-reconstructed secret information being difficult to duplicate.

10. A device authenticity determination system according to claim 2, wherein the semiconductor chip performs the comparison processing in the tampering determination function by comparing results of hash calculation using the secret information as key information.

11. A device authenticity determination system according to claim 7,
wherein based on an operation of a maintenance person, the control terminal transmits a printed information reissuance request comprising the auxiliary data to the server,
wherein when receiving the printed information reissuance request from the control terminal, the server uses the second secret information to generate new printed information to which maintenance information is added, and returns the generated new printed information to the control terminal that has transmitted the printed information reissuance request, and
wherein the control terminal reprints the new printed information in order that the printed information, which is viewable, is updated with the received new printed information.
